(19) United States
(12) Patent Application Publication
(10) Pub. No.: US 2026/0050765 A1
(43) Pub. Date: Feb. 19, 2026

(54) METHOD AND SYSTEM FOR AN ARTIFICIAL INTELLIGENCE (AI) AGENT FRAMEWORK PERFORMING WORKFLOW ANALYTICS

(71) Applicant: JPMorgan Chase Bank, N.A., New York, NY (US)

(72) Inventor: Yingzhao ZHOU, Hook (GB)

(73) Assignee: JPMorgan Chase Bank, N.A., New York, NY (US)

(21) Appl. No.: 18/805,220

(22) Filed: Aug. 14, 2024

(51) Int. Cl. G06N 3/045; G06F 11/36; G06N 3/042; G06N 3/096

(52) U.S. Cl. CPC G06N 3/045; G06F 11/3696; G06N 3/042; G06N 3/096

(57) ABSTRACT

A method and system of performing workflow analytics. The method includes implementing a first large language model (LLM) and creating a linked chain of LLMs via a model integration framework linking the first LLM with at least a second LLM. The method further includes implementing at least one analytical software tool from a tool registry such that each of the at least one analytical software tool is configured to perform a respective data analytics function, and implementing at least one software agent such that each is configured to perform at least one respective operational task. The method further includes generating an artificial intelligence (AI) agent framework by connecting the linked chain of LLMs with the at least one analytical software tool and the at least one software agent, and performing the workflow analytics via the AI agent framework.

### BACKGROUND

### Field of the Disclosure

This technology generally relates to methods and systems for an artificial intelligence (AI) agent framework performing workflow analytics.

### Background Information

Environmental management tasks used to be performed internally with an internal application support team. However, present business operations are often spread across global locations with multiple different operating environments that perform workflow analytics and utilize numerous external support teams for the multiple different operating environments in performing these workflow analytics. This is problematic because the utilization of external support teams for the multiple different operating environments in performing these workflow analytics introduces numerous manual errors and involves too much manual effort. That is, it results in high cost, low efficiency, high errors, and a waste of resources. Furthermore, a solution that may work for one operating environment may not be applicable to another operating environment and as a result, the solution does not scale to all lines of the business operations.

Accordingly, there is a need for techniques for an artificial intelligence (AI) agent framework performing workflow analytics.

### SUMMARY

The present disclosure, through one or more of its various aspects, embodiments, and/or specific features or sub-components, provides, inter alia, various systems, servers, devices, methods, media, programs, and platforms for an artificial intelligence (AI) agent framework performing workflow analytics.

According to an aspect of the present disclosure, a method for an AI agent framework performing workflow analytics may be provided. The method of performing workflow analytics may be implemented by at least one processor. The method may include implementing a first large language model (LLM); creating a linked chain of LLMs via a model integration framework linking the first LLM with at least a second LLM; implementing at least one analytical software tool from a tool registry such that each of the at least one analytical software tool may be configured to perform a respective data analytics function; implementing at least one software agent such that each may be configured to perform at least one respective operational task; generating an artificial intelligence (AI) agent framework by connecting the linked chain of LLMs with the at least one analytical software tool and the at least one software agent; and performing the workflow analytics via the AI agent framework.

The at least one analytical software tool may comprise: a web crawler software tool configured to perform a first data analytics function of parsing data from web derived sources, wherein the web derived sources comprise at least one from among email data objects, web-based incident reports, and web-based application data; a monitoring software tool configured to perform a second data analytics function of analyzing, tracking, and parsing incident reports and alerts; a database software tool configured to perform a third data analytics function of analyzing, organizing, cataloging, and managing data within the database; a log scanning software tool configured to perform a fourth data analytics function of analyzing data logs; and a chatbot software tool configured to perform a fifth data analytics function of managing a chatbot and functions of the chatbot.

The at least one software agent may comprise at least one from among: an incident analysis software agent configured to perform an incident management task; a LLM test software agent configured to perform a test task of testing a performance of at least one from among the first LLM and the at least second LLM; a LLM comparison software agent configured to perform a comparison task of comparing the first LLM with the at least second LLM; a test case refinement software agent configured to perform a test case task of refining a test case; a decision-making software agent configured to perform a decision task that includes analyzing user queries, interacting with a knowledge base and at least one from among the first LLM and the at least second LLM, and deciding on an action; and an action execution software agent configured to perform an action execution task of executing the decided action.

The method may further include performing data pre-processing of data that comprises: splitting the data into categories; cleaning of the data; tokenization of the data; and natural language processing of the data comprising stemming and lemmatization of the data.

The performing the workflow analytics may comprise: connecting with a cloud computing server and performing data tokenization to generate optimized data for utilization by at least one from among the first LLM and the at least second LLM within the AI framework; generating embeddings of structured data and generating an index of the embeddings; training the linked chain of LLMs based on a knowledge base derived from a vector database; validating at least one from among the first LLM and the at least second LLM by generating a score associated with a response result from at least one from among the first LLM and the at least second LLM to a prompt, wherein the response result comprises a tree response result; and deploying the validated at least one from among the first LLM and the at least second LLM.

The training the linked chain of LLMs may comprise: fine-tuning the linked chain of LLMs; and performing few-shot prompting to generate the response result.

The performing the workflow analytics may further comprise: receiving a query prompt from a user; and performing prompt engineering on the received query prompt.

According to another embodiment, a computing apparatus for performing workflow analytics may be provided. The computing apparatus may comprise: a processor; a memory; a display; and a communication interface coupled to each of the processor, the memory, and the display.

The processor may be configured to implement a first large language model (LLM); create a linked chain of LLMs via a model integration framework linking the first LLM with at least a second LLM; implement at least one analytical software tool from a tool registry such that each of the at least one analytical software tool may be configured to perform a respective data analytics function; implement at least one software agent such that each may be configured to perform at least one respective operational task; generate an artificial intelligence (AI) agent framework by connecting the linked chain of LLMs with the at least one analytical software tool and the at least one software agent; and perform the workflow analytics via the AI agent framework.

The at least one analytical software tool may comprise: a web crawler software tool configured to perform a first data analytics function of parsing data from web derived sources, wherein the web derived sources comprise at least one from among email data objects, web-based incident reports, and web-based application data; a monitoring software tool configured to perform a second data analytics function of analyzing, tracking, and parsing incident reports and alerts; a database software tool configured to perform a third data analytics function of analyzing, organizing, cataloging, and managing data within the database; a log scanning software tool configured to perform a fourth data analytics function of analyzing data logs; and a chatbot software tool configured to perform a fifth data analytics function of managing a chatbot and functions of the chatbot.

The at least one software agent may comprise at least one from among: an incident analysis software agent configured to perform an incident management task; a LLM test software agent configured to perform a test task of testing a performance of at least one from among the first LLM and the at least second LLM; a LLM comparison software agent configured to perform a comparison task of comparing the first LLM with the at least second LLM; a test case refinement software agent configured to perform a test case task of refining a test case; a decision-making software agent configured to perform a decision task that includes analyzing user queries, interacting with a knowledge base and at least one from among the first LLM and the at least second LLM, and deciding on an action; and an action execution software agent configured to perform an action execution task of executing the decided action.

The processor may be further configured to perform data pre-processing of data that may comprise: splitting the data into categories; cleaning of the data; tokenization of the data; and natural language processing of the data comprising stemming and lemmatization of the data.

The processor may be further configured to perform the workflow analytics by: connecting with a cloud computing server and performing data tokenization to generate optimized data for utilization by at least one from among the first LLM and the at least second LLM within the AI framework; generating embeddings of structured data and generating an index of the embeddings; training the linked chain of LLMs based on a knowledge base derived from a vector database; validating at least one from among the first LLM and the at least second LLM by generating a score associated with a response result from at least one from among the first LLM and the at least second LLM to a prompt, wherein the response result comprises a tree response result; and deploying the validated at least one from among the first LLM and the at least second LLM.

The processor may be further configured to train the linked chain of LLMs by: fine-tuning the linked chain of LLMs; and performing few-shot prompting to generate the response result; and wherein the processor may be further configured to perform the workflow analytics by: receiving a query prompt from a user; and performing prompt engineering on the received query prompt.

According to yet another embodiment, a non-transitory computer readable storage medium storing instructions for performing workflow analytics may be provided. The non-transitory computer readable storage medium comprising executable code which, when executed by a processor, causes the processor to: implement a first large language model (LLM); create a linked chain of LLMs via a model integration framework linking the first LLM with at least a second LLM; implement at least one analytical software tool from a tool registry such that each of the at least one analytical software tool may be configured to perform a respective data analytics function; implement at least one software agent such that each may be configured to perform at least one respective operational task; generate an artificial intelligence (AI) agent framework by connecting the linked chain of LLMs with the at least one analytical software tool and the at least one software agent; and perform the workflow analytics via the AI agent framework.

The at least one analytical software tool may comprise: a web crawler software tool configured to perform a first data analytics function of parsing data from web derived sources, wherein the web derived sources comprise at least one from among email data objects, web-based incident reports, and web-based application data; a monitoring software tool configured to perform a second data analytics function of analyzing, tracking, and parsing incident reports and alerts; a database software tool configured to perform a third data analytics function of analyzing, organizing, cataloging, and managing data within the database; a log scanning software tool configured to perform a fourth data analytics function of analyzing data logs; and a chatbot software tool configured to perform a fifth data analytics function of managing a chatbot and functions of the chatbot.

The at least one software agent may comprise at least one from among: an incident analysis software agent configured to perform an incident management task; a LLM test software agent configured to perform a test task of testing a performance of at least one from among the first LLM and the at least second LLM; a LLM comparison software agent configured to perform a comparison task of comparing the first LLM with the at least second LLM; a test case refinement software agent configured to perform a test case task of refining a test case; a decision-making software agent configured to perform a decision task that includes analyzing user queries, interacting with a knowledge base and at least one from among the first LLM and the at least second LLM, and deciding on an action; and an action execution software agent configured to perform an action execution task of executing the decided action.

The executable code may further cause the processor to perform data pre-processing of data that may comprise: splitting the data into categories; cleaning of the data; tokenization of the data; and natural language processing of the data comprising stemming and lemmatization of the data.

The executable code may further cause the processor to perform the workflow analytics that may comprise: connecting with a cloud computing server and performing data tokenization to generate optimized data for utilization by at least one from among the first LLM and the at least second LLM within the AI framework; generating embeddings of structured data and generating an index of the embeddings; training the linked chain of LLMs based on a knowledge base derived from a vector database; validating at least one from among the first LLM and the at least second LLM by generating a score associated with a response result from at least one from among the first LLM and the at least second LLM to a prompt, wherein the response result comprises a tree response result; and deploying the validated at least one from among the first LLM and the at least second LLM.

The executable code may further cause the processor to train the linked chain of LLMs by: fine-tuning the linked chain of LLMs; and performing few-shot prompting to generate the response result.

The executable code may further cause the processor to perform the workflow analytics by: receiving a query prompt from a user; and performing prompt engineering on the received query prompt.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for an artificial intelligence (AI) agent framework performing workflow analytics.

FIG. 4 illustrates a flowchart of a process for an AI agent framework performing workflow analytics according to an embodiment.

FIG. 5a illustrates an example in-depth overview process flow of an AI agent framework performing workflow analytics according to an embodiment.

FIG. 5b illustrates a continuation of the in-depth example overview process flow of an AI agent framework performing workflow analytics according to an embodiment.

FIG. 6 illustrates an example AI agent framework that may include a virtual support agent performing workflow analytics according to an embodiment.

FIG. 7 illustrates an example operating environment of an AI agent framework performing workflow analytics according to an embodiment.

FIG. 8 illustrates an example overview process flow of an AI agent framework performing workflow analytics according to an embodiment.

### DETAILED DESCRIPTION

Environmental management tasks used to be performed internally with an internal application support team. However, present business operations are often spread across global locations with multiple different operating environments that perform workflow analytics and utilize numerous external support teams for the multiple different operating environments in performing these workflow analytics. This is problematic because the utilization of external support teams for the multiple different operating environments in performing these workflow analytics introduces numerous manual errors and involves too much manual effort. That is, it results in high cost, low efficiency, high errors, and a waste of resources. Furthermore, a solution that may work for one operating environment may not be applicable to another operating environment and as a result, the solution does not scale to all lines of the business operations.

The majority of the workflow analytics and operational activities being performed by the external support teams with a e.g., Level 3 (L3) support capability, i.e., software developers capable of addressing issues with performing the workflow analytics. That is, the L3 team may denote persons (e.g., software developers) with subject matter expertise regarding e.g., the workflow analytics, the operating environments associated with performing the workflow analytics, computing systems or environments associated with performing the workflow analytics, troubleshooting the various workflow analytics issues and/or various environment as previously described, etc. Upon an analysis by the L3 external support team, the L3 external support team may then generally route the identified issues to an application development (AD) team to resolve, i.e., an advanced support team capable of resolving advanced issues.

Instead of being limited to having troubleshooting and support by the external support teams with L3 support capable, there is a need to building a comprehensive and tailored application support environment that provides support teams capable of wide variety of level support (e.g., L1, L2 and L3) with the different levels of support model that enables the various respective support teams to easily identify the issue, comprehend the issue, and triage the issue to the appropriate teams that have the proper level of support. Doing so may also help the AD team as well since most issues are presently routed to them when there might not be a need to do so.

Additionally, given the present dual challenges of a high number of issues and a limited budget for environment support teams, it is not feasible to solely rely on manual efforts to analyze, identify, triage, and address these issues. Additionally, when a solution is found, it also may not be feasible to scale the solution across multiple operating environments by manual effort.

The L1 team may denote persons without the level of understanding needed to troubleshoot issues. The L1 team may operate primarily to note errors and report such errors for a higher level team to address. One level up from the L1 team may be the L2 team. The L2 may denotes person with a minimal level of understanding to troubleshot issues. One level up from the L2 team may be the L3 team, which was previously described above.

Therefore, for the reasons stated above, there exists a need to leverage AI agents. Notably, an AI agent framework that may include a plurality, i.e., a farm of AI agents for performing the workflow analytics (such as millions of workflow analytics) by e.g., automatically monitoring and analyzing the multiple different operating environments, e.g., thousands of different operating environments. The AI agent framework may be built on top of a machine learning (ML) framework and may use the ML framework for training and collaboration, enabling the AI agent framework in conjunction with the ML framework that may include ML models memory capacity, enabling comprehensive automation across multiple different operating environments.

Potential applications for the AI agent framework in conjunction with the ML framework may be utilized in production management, enabling increased resource efficiency and capacity. Another potential application may be in use cases that streamline creations of business application without purely relying on manual effort.

The present application addresses the limitations in the status quo by disclosing an AI agent framework performing workflow analytics, wherein the AI agent framework may be built on top of a ML framework.

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

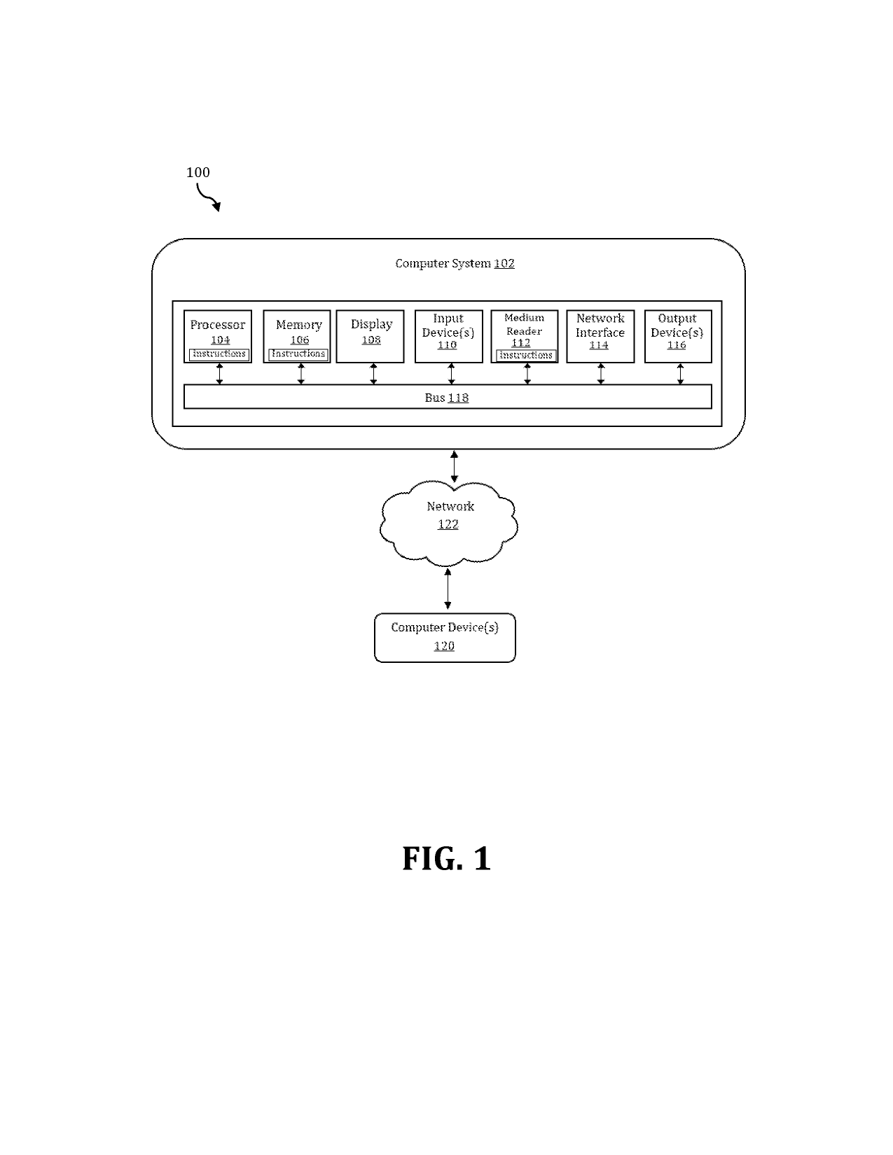

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide optimized methods and systems for an AI agent framework performing workflow analytics.

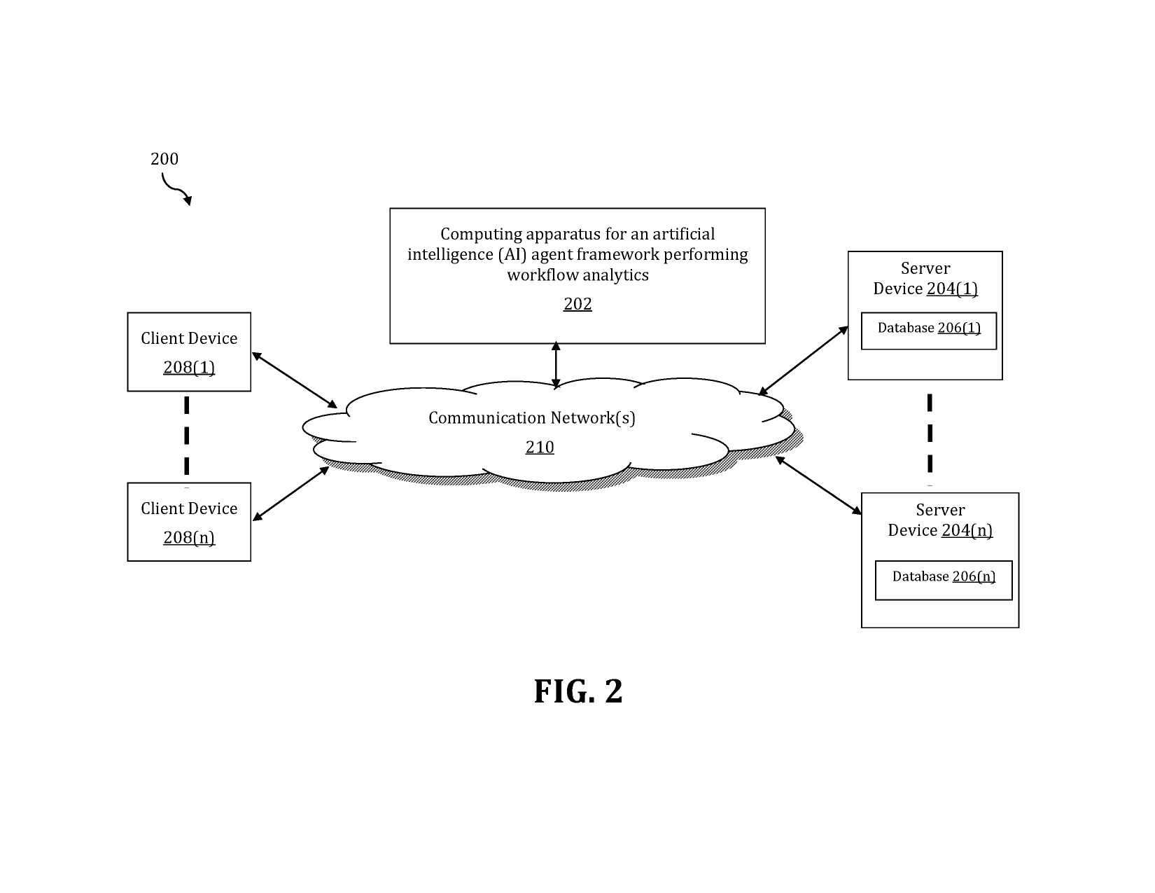

Referring to FIG. 2, a network diagram of a network environment 200 for an AI agent framework performing workflow analytics may be illustrated. In an embodiment, the method may be executable on any networked computer platform, such as, for example, a personal computer (PC).

The method of an AI agent framework performing workflow analytics may be implemented by a computing apparatus 202 that implements the AI agent framework performing workflow analytics. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method of an AI agent framework performing workflow analytics.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

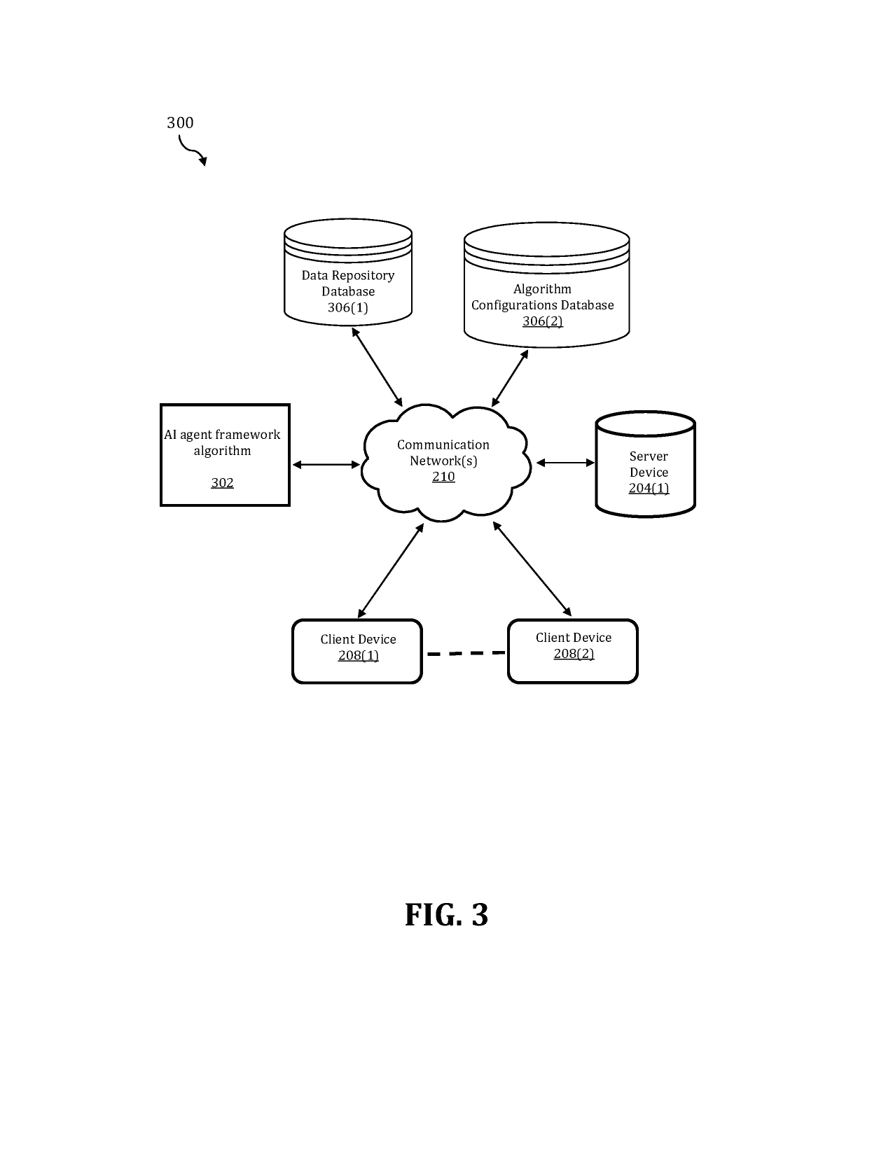

The computing apparatus 202 may be described and illustrated in FIG. 3 as including an artificial intelligent (AI) framework algorithm 302, although it may include other rules, algorithms, policies, modules, databases, or applications, for example. As will be described below, the AI agent framework algorithm 302 may be configured to implement a method of an AI agent framework performing workflow analytics.

FIG. 3 illustrates a diagram of a system environment 300 for implementing a method of an AI agent framework performing workflow analytics of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository database 306(1) and an algorithm configurations database 306(2). The AI agent framework algorithm 302 may be configured to access these databases for implementing an AI agent framework performing workflow analytics.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

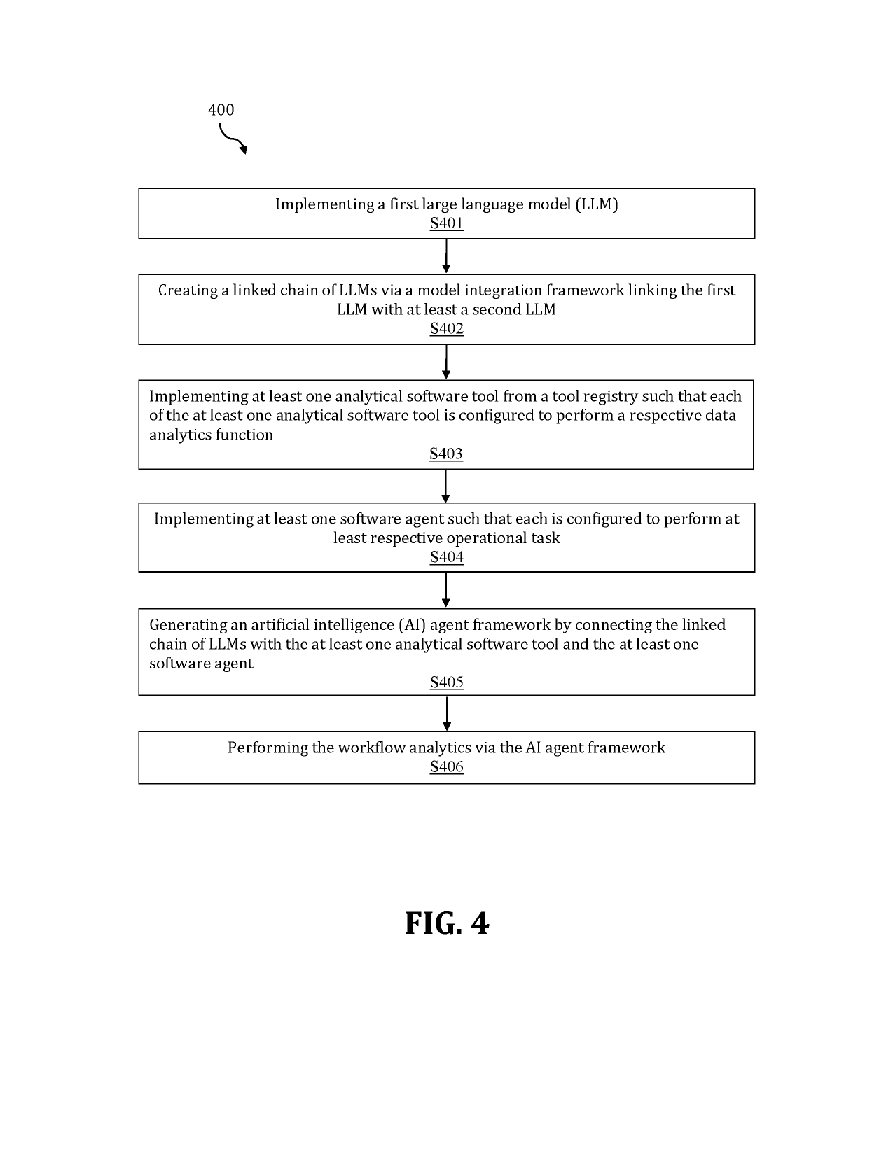

Upon being started, the AI agent framework algorithm 302 executes a process implementing a method of an AI agent framework performing workflow analytics. A process for an AI agent framework performing workflow analytics may be generally indicated at flowchart 400 in FIG. 4.

FIG. 4 illustrates a flowchart of a process diagram 400 for an AI agent framework performing workflow analytics according to an embodiment. At step S401 of the flowchart process 400, the computing apparatus 202 may implement a first large language model (LLM). In an example, the LLMs may have short-term or long-term memories.

At step S402, the computing apparatus 202 may create a linked chain of LLMs via a model integration framework linking the first LLM with at least a second LLM. In an example, the model integration framework may be a LLM workflow definition or application creation tool that chains together a plurality of LLMs to generate a linked chain of LLMs. The model integration framework may be an existing tool that chains the LLMs together and may be assign short-term or long-term memory to the LLMs. In an example, the model integration framework may be a software that may enable a framework for building a chain of LLMs with different agent operations.

At step S403, the computing apparatus 202 may implement at least one analytical software tool from a tool registry such that each of the at least one analytical software tool may be configured to perform a respective data analytics function. That is, once an LLM agent has been implemented and built, then additional LLMs with multiple different capabilities like decision making agent, action execution agent, or training agent maybe also be built and these agents may be chained together using the model integration framework to chain the different LLMs together.

Continuing with step S403, the at least one analytical software tool may include a web crawler software tool may be configured to perform a first data analytics function of parsing data from web derived sources, wherein the web derived sources comprise at least one from among email data objects, web-based incident reports, and web-based application data. The least one analytical software tool may also include a monitoring software tool that may be configured to perform a second data analytics function of analyzing, tracking, and parsing incident reports and alerts.

Continuing with step S403, the at least one analytical software tool may also include a database software tool may be configured to perform a third data analytics function of analyzing, organizing, cataloging, and managing data within the database. The at least one analytical software tool may also include a log scanning software tool may be configured to perform a fourth data analytics function of analyzing data logs. The at least one analytical software tool may also include a chatbot software tool may be configured to perform a fifth data analytics function of managing a chatbot and functions of the chatbot.

At step S404, the computing apparatus 202 may implement at least one software agent such that each of the at least one software agent may be configured to perform at least one respective operational task. The at least one software agent may include at least one from among: an incident analysis software agent may be configured to perform an incident management task; a LLM test software agent may be configured to perform a test task of testing a performance of at least one from among the first LLM and the at least second LLM; a LLM comparison software agent may be configured to perform a comparison task of comparing the first LLM with the at least second LLM; a test case refinement software agent may be configured to perform a test case task of refining a test case; a decision-making software agent may be configured to perform a decision task that includes analyzing user queries, interacting with a knowledge base and at least one from among the first LLM and the at least second LLM, and deciding on an action; and an action execution software agent may be configured to perform an action execution task of executing the decided action.

At step S405, the computing apparatus 202 via the AI agent framework algorithm 302 may generate an AI agent framework by connecting the linked chain of LLMs with the at least one analytical software tool and the at least one software agent.

At step S406, the computing apparatus 202 may perform the workflow analytics via the AI agent framework. The performing the workflow analytics via the AI agent framework may comprise connecting with a cloud computing server and performing data tokenization to generate optimized data for utilization by at least one from among the first LLM and the at least second LLM within the AI framework and generating embeddings of structured data and generating an index of the embeddings.

Continuing with step S406, the performing the workflow analytics via the AI agent framework may also comprise training the linked chain of LLMs based on a knowledge base derived from a vector database (DB) and validating at least one from among the first LLM and the at least second LLM by generating a score associated with a response result from at least one from among the first LLM and the at least second LLM to a prompt, wherein the response result comprises a tree response result. The training the linked chain of LLMs may comprise fine-tuning the linked chain of LLMs; and performing few-shot prompting to generate the response result. The fine-tuning may include fine-tuning of hyperparameters (number of epochs, batch size, learning rate, etc.), as well as fine-tuning of any other metric of the LLM as desired.

Continuing with step S406, the performing the workflow analytics via the AI agent framework may also comprise deploying the validated at least one from among the first LLM and the at least second LLM for utilization. The performing the workflow analytics via the AI agent framework may also comprise receiving a query prompt from a user, and performing prompt engineering on the received query prompt.

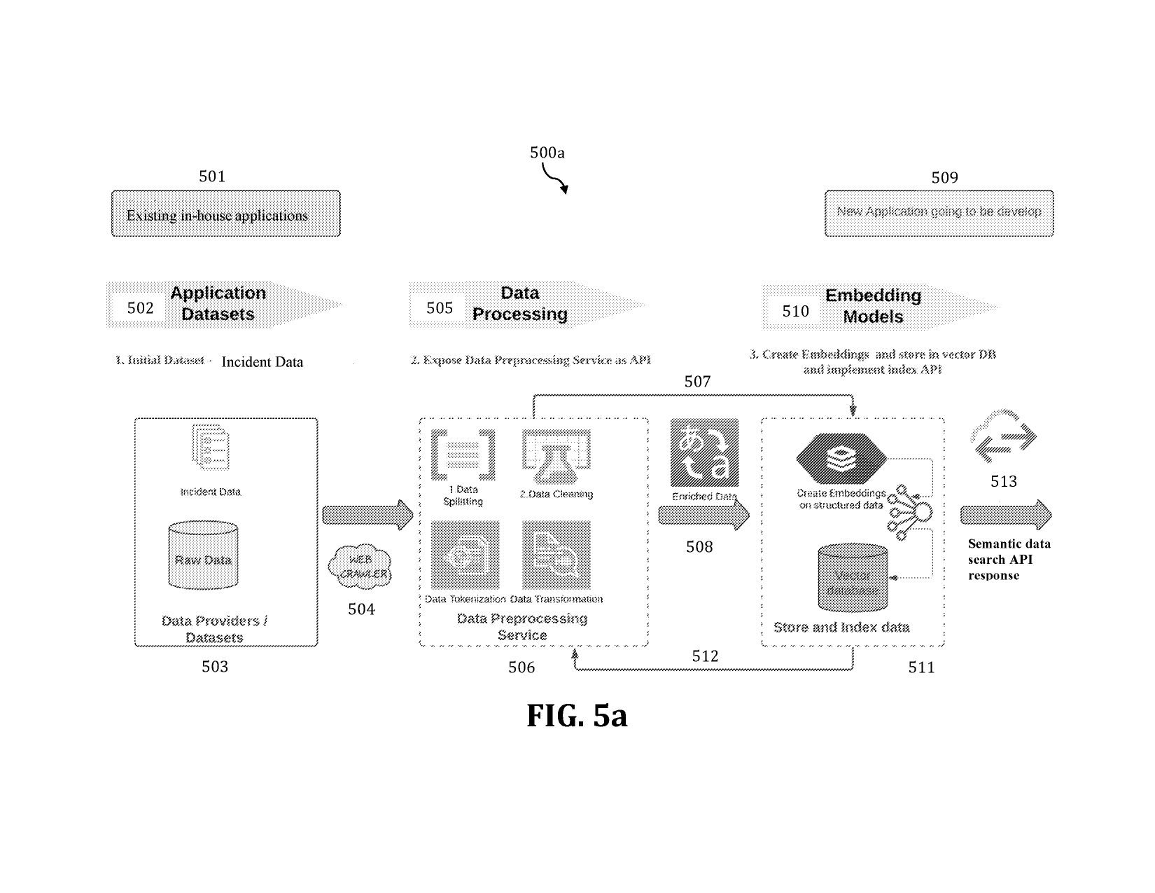

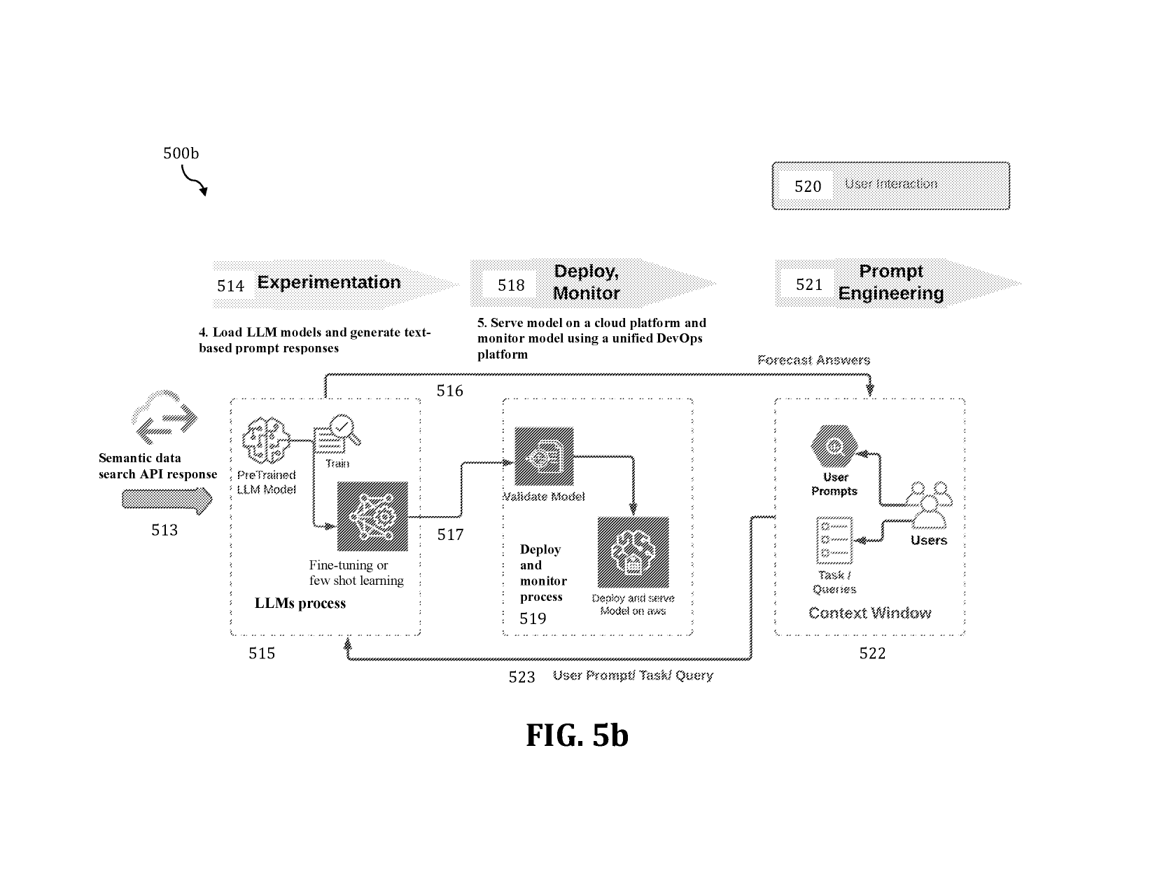

FIG. 5a illustrates an example in-depth overview process flow 500a of an AI agent framework performing workflow analytics according to an embodiment. The in-depth overview process flow 500a may show existing in-house applications 501 that may presently be in use by the business organization. For example, the existing in-house applications 501 may be a system management platform for real-time monitoring of application processes, information technology (IT) infrastructure, computing systems or environments, cloud or virtual systems or environments, alerts, etc. Another example of existing in-house applications 501 may be a web-based platform for remote knowledge and content sharing that may include e.g., but not limited, data collaboration and management, project management, data links, etc. Another example of the existing in-house applications 501 may be a cloud computing platform for managing digital workflows for enterprise/business operations that may include management of incident data.

At step 1 of the in-depth overview process flow 500a, application datasets 502 may be gathered. The application datasets 502 may include an initial dataset of incident data. That is, the application datasets 502 may include data from data providers / datasets 503 with incident data and raw data (e.g., millions of such incident data and raw data) being gathered from the existing in-house applications 501. For instance, data regarding alerts from the system management platform for real-time monitoring of alerts may be parsed, wherein the system management platform for real-time monitoring may generate email alerts that may then be parsed to obtain alert data information, resulting in a parsed email data object. In an example, an AI agent may be configured to perform the parsing.

Continuing with step 1, in another example, data regarding data knowledge and data content links may be parsed, resulting in a parsed data object. In an example, a web crawler 504 of an AI agent may be configured to traverse the various data content links and parse the data content links for data knowledge.

Continuing with step 1, in another example, data regarding incident data from the cloud computing platform may be parsed, resulting in a parsed data object. The incident data may include incident data per a particular enterprise group/division, as well as response data regarding the incident. In an example, an AI agent may be configured to perform the parsing.

At step2 of the in-depth overview process flow 500a, data processing 505 may be performed, wherein the data gathered from step1 may be exposed as part of a data pre-processing service as an application program interface (API). In an example, a web crawler 504 of an AI agent may be configured to obtain the various data from the data providers / datasets 503 for transmission into a data pre-processing service 506. The data pre-processing service 506 may include, but is not limited to, data splitting, data cleaning, data tokenization, and data transformation. Data splitting may include obtaining tabular data from the web crawler 504 that may include incident data, wherein the incident data may be separated and cataloged based on categories such as, but not limited to: urgency level, incident number, root cause, region/location, title, application name, and/or expected flow corresponding to a knowledge base. Data cleaning may include removal of client name, date the incident/issue ticket/report was opened, date the incident/issue was resolved, mean time to resolve, person associated with raising the issue, owner of the data, and improvement data. Data tokenization may include converting sentences to words, and removing unnecessary data such as, but not limited to, punctuation, tags, and stop words. Data transformation may include stemming and lemmatization of the data.

Pre-processing of the data by the pre-processing service 506 may then result in data for transmission 507 such as enriched data 508 that may be transmitted to embedding models 510, wherein a new application may be developed 509 that may occur at step 3 of the in-depth overview process flow 500a. Notably, the enriched data 508 and the pre-processed data may be transmitted 507 to step 3 to create embedding models 510. Step 3 may include creating embeddings for the embedding models and storing the embeddings and embedding models in a vector DB, as well as implementing an index application program interface (API) based on the embeddings and embedding models. That is, the store and index data 511 may include creation of embeddings on structured data of the enriched data 508 and the transmitted pre-processed data 507, and then storage of these creations (e.g., the embeddings and embedding models) in the vector DB. In an example, an AI agent may connect to a cloud platform for servicing machine learning (ML) models or LLMs. The AI agent may connect to the cloud platform by e.g., using a tenant identification (ID) or a client ID, and generating a token that may enable a connection with the cloud platform.

Continuing with step 3, in another example, an AI agent may create tokens to optimize data using a model integration framework that may be available on the cloud platform. In another example, an AI agent may generate embeddings of the parsed data using the model integration framework and generate an index of these embeddings. In another example, an AI agent may save and store the generated embeddings of the parsed data in a vector DB. The parsed data may be the enriched data 508 and/or the transmitted pre-processed data 507.

Continuing with step 3, the embedding models and embeddings may then be transmitted to additional processes as shown in FIG. 5b via a semantic data search API response 513. Additionally, the embeddings, embedding models, and/or stored and index data via the store and index data 511 may be transmitted back 512 to the data pre-preprocessing service 506 for additional data pre-processing as desired.

FIG. 5b illustrates a continuation of the in-depth example overview process flow 500b of an AI agent framework performing workflow analytics according to an embodiment. The semantic data search API response 513 may enable data transfers between the processes as depicted in FIG. 5a of the in-depth example overview process flow 500a with the continuation of the in-depth example overview process flow 500b as depicted in FIG. 5b. Data from the semantic data search API response 513 may transmitted for experimentation 514 by, e.g., the LLMs. In an example, the experimentation 514 at step 4 may include loading LLMs and generating text-based prompt responses. The LLMs process 515 may include utilizing pre-trained LLMs as a base model and training these pre-trained LLMs in addition to performing fine-tuning or few-shot learning of the LLMs.

Continuing with step 4, an AI agent may load the pre-trained LLM(s) to act as a base LLM(s) for training. A prompt from a user or the operating environment/system may be considered as input for the training. Once the loading is complete, the AI agent may train LLM(s) using a knowledge base that may be generated by loading a response from the vector DB. The AI agent may perform fine-tuning of the LLM(s) as part of the training. The fine-tuning may include fine-tuning of hyperparameters (number of epochs, batch size, learning rate, etc.), as well as fine-tuning of any other metric of the LLM(s) as desired. Additionally, few-shot prompting may also be performed on the LLMs to generate a tree-of-thoughts prompts. The results from the fine-tuning and/or few-shot prompting may then be transmitted 517 for validation of the LLM at a deploy and monitor process 518 at step 5. Additionally, the LLMs may be used to forecast answers 516.

At step 5 of the continuation of the in-depth example overview process flow 500b, deployment and monitoring 518 of the LLMs may be performed. The LLMs may be the trained LLMs that was trained in step 4 at the LLMs process 515. Step 5 may include serving the model (e.g., the LLMs) on a cloud platform and monitoring the model using a unified development operations (DevOps) platform for generating, developing, and running applications based on LLMs. For example, the DevOps platform.

Continuing with step 5, deployment and monitoring processes 519 may be performed. In an example, an AI agent may validate the LLM. The AI agent may use the unified DevOps platform for model observation and to generate scores for every prompt response and maintain those scores. Additionally, an AI agent may deploy the trained LLM on a cloud platform cluster and the AI agent may operate in the cloud platform environment and take actions as needed regarding the LLM on the cloud platform cluster.

The continuation of the in-depth example overview process flow 500b may also include a user interaction process 520 that may include prompt engineering 521, which may include a context window 522. The context window 522 may include user prompts and task/queries received from users, which may be used as for prompt engineering 521. In an example, an AI agent may receive the user prompts and task/queries from users through a chatbot via a chatbot application or a user interface (UI) via a UI application. Additionally, the context window 522 may also receive forecast answers 516 from the trained LLMs from the LLMs process 515.

Furthermore, an AI agent may receive a prompt/query regarding incident data and the AI agent may transmit data from the cloud computing platform for managing digital workflows for enterprise/business operations back to the LLM. That is, the user prompt / task / query 523 may be transmitted back to the LLMs process 515 to help train the LLMs, as well as for the few-shot prompting.

Notably the processes as described in FIGS. 5a and 5b enable the AI framework that may support a farm of AI agents performing millions of workflow analytics across thousands of multiple different operating environments in an efficient and expedient manner and that minimizes manual effort and errors, reduces computing costs, and reduces a waste of resources. Computing costs and waste of resources may be reduced because the incidents and issues may be more easily monitored, tracked and identified/diagnosed, as well as properly triaged to the appropriate team to handle.

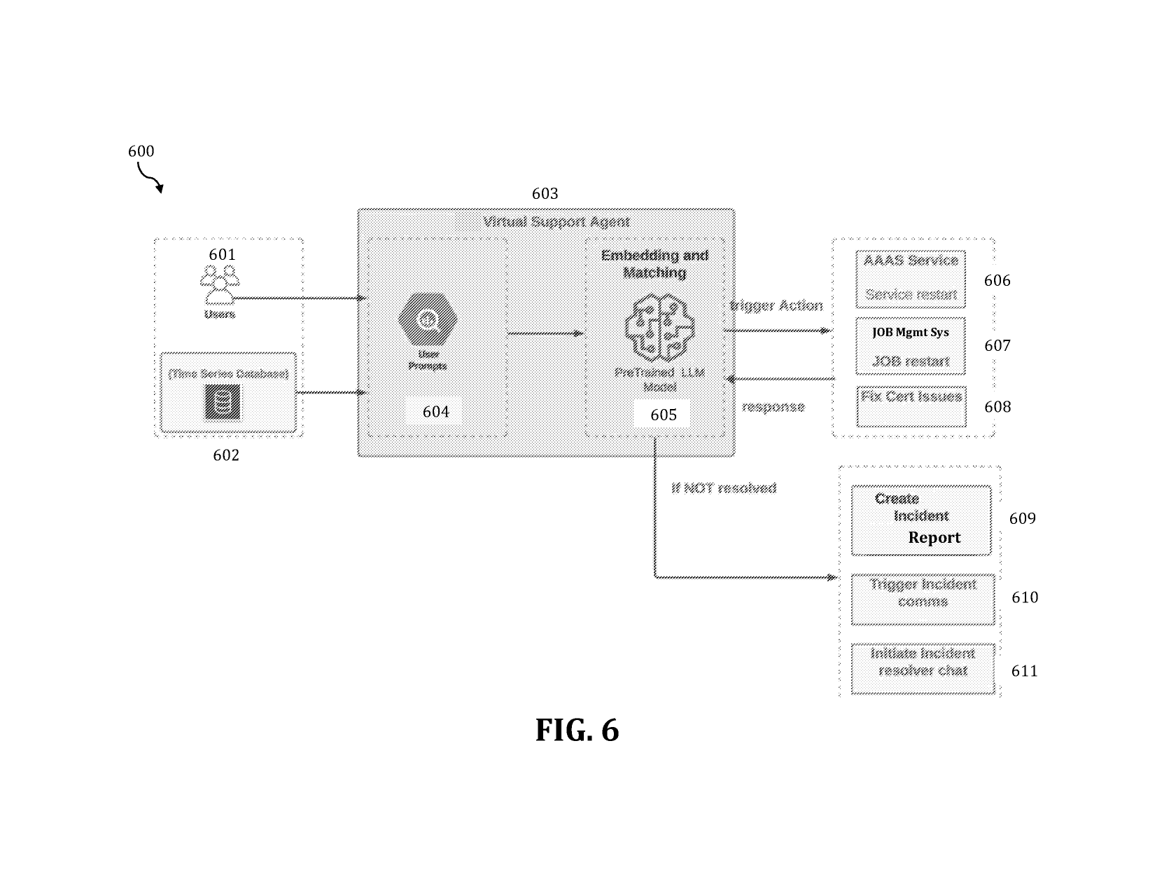

FIG. 6 illustrates an example AI agent framework that may include a virtual support agent performing workflow analytics 600 according to an embodiment. Data may be received from users 601 and/or database 602 (such as a time series database) that may be inputted as user prompts 604 into a virtual support agent 603. The virtual support agent 603 may an AI agent. The virtual support agent 603 may receive the user prompts 604 and transmit the user prompts 604 to a pre-trained LLM 605 for embedding and matching operations. The pre-trained LLM 605 may trigger an action such as, but not limited to: analytics as a service (AAAS) 606 that may include a service restart; a job management (mgmt) system 607 that may include a job restart; and/or fixing of certification issues 608. A response to these actions may be transmitted back to the pre-trained LLMs 605.

Continuing with FIG. 6, if the issue is not resolved, then additional actions may be taken, e.g., but not limited to: creating an incident report 609, generating incident communications (comms) 610, and/or a initiating a resolver chat 611 to discuss and resolve the issue.

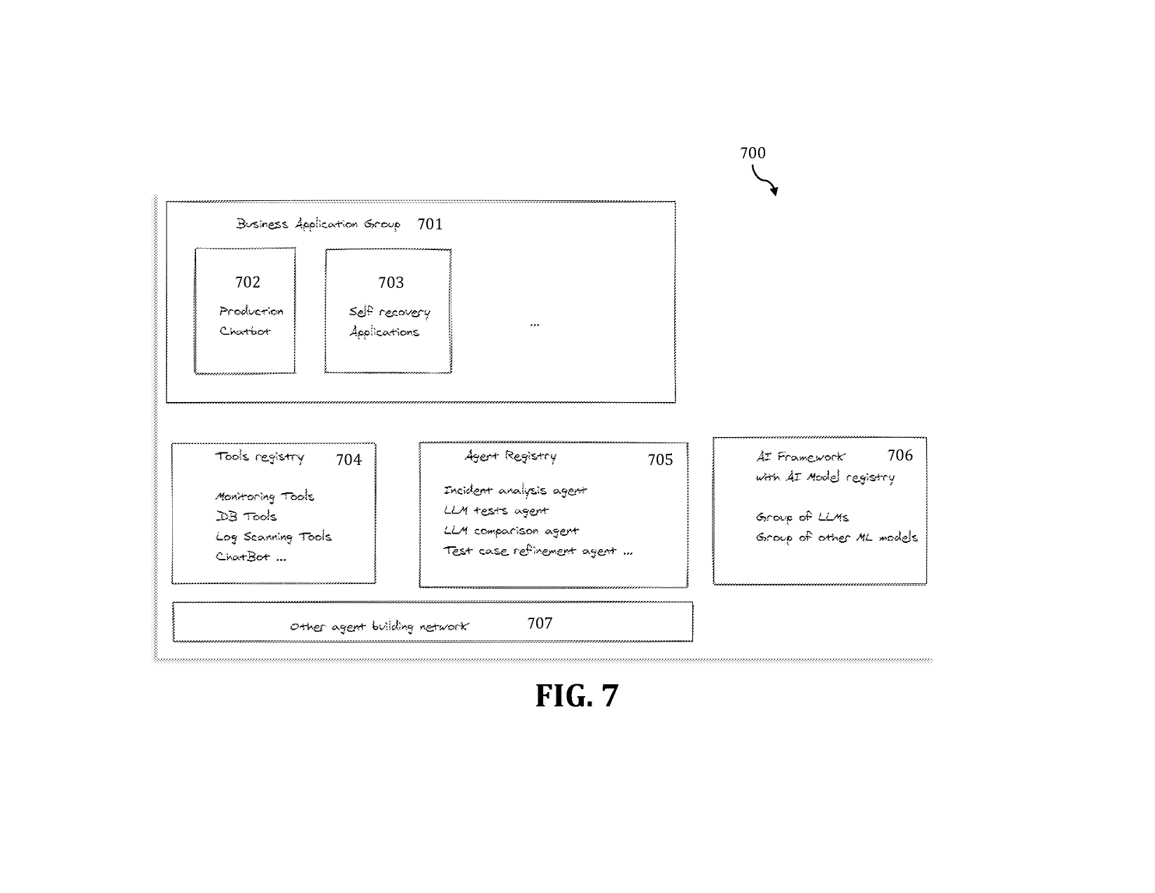

FIG. 7 illustrates an example operating environment 700 of an AI agent framework performing workflow analytics according to an embodiment. The example operating environment 700 of the AI agent framework may include a business application group 701. The business application group 701 may include a production chatbot 702 and self-recovery applications 703. The example operating environment 700 may also include a registry of tools. The tools may be standard or custom tools that the agent may utilize to perform certain monitoring, reporting, logging, etc. tasks.

Continuing with FIG. 7, examples of a tools registry 704 (i.e., analytical software tool) may include, but are not limited to: monitoring tools, database (DB) tools, log scanning tools, and/or chatbots. The analytical software tool may include, but is not limited to: a web crawler software tool configured to perform a first data analytics function of parsing data from web derived sources, wherein the web derived sources comprise at least one from among email data objects, web-based incident reports, and web-based application data; a monitoring software tool configured to perform a second data analytics function of analyzing, tracking, and parsing incident reports and alerts; a database software tool configured to perform a third data analytics function of analyzing, organizing, cataloging, and managing data within the database; a log scanning software tool configured to perform a fourth data analytics function of analyzing data logs; and a chatbot software tool configured to perform a fifth data analytics function of managing a chatbot and functions of the chatbot.

Continuing with FIG. 7, the agent registry 705 of the AI agent framework may have an AI model registry wherein the pre-trained LLMs may be stored and utilized by the business/enterprise. Additionally, the agent registry 705 may include various types of different agents. Examples of these agents in the agent registry 705 may include, but are not limited to: incident analysis agent, LLM tests agent for testing LLMs, LLM comparison agent for comparing different LLMs, test case refinement agent for refining test cases, etc. The AI agent registry may store all relevant agents in, e.g., database or other storage environments, for use by the various divisions of the business and enterprises. These AI agents may include, but are not limited to: a decision-making software agent to perform a decision task that includes analyzing user queries, interacting with a knowledge base and at least one from among the first LLM and the at least second LLM, and deciding on an action; an action execution software agent to perform an action execution task of executing the decided action; an incident analysis software agent to perform an incident management task; a LLM test software agent to perform a test task of testing a performance of at least one from among the first LLM and the at least second LLM; a LLM comparison software agent to perform a comparison task of comparing the first LLM with the at least second LLM; and/or a test case refinement software agent to perform a test case task of refining a test case.

Continuing with FIG. 7, the decision-making software agent may analyze user queries, interact with the LLM and knowledge base, and decide on the appropriate action. The action execution software agent may execute the actions determined by the decision-making agent, which may involve accessing application APIs (e.g., retrieving logs, initiating configuration changes, etc.). The action execution software agent may also generate reports or provide step-by-step instructions.

Continuing with FIG. 7, examples of the AI agent framework with AI model registry 706 may include, but are not limited to: group of LLMs, group of other machine learning (ML) models, etc. Additionally, the example operating environment 700 may also include other agent building networks 707. The AI agent framework may be an algorithm for performing workflow analytics, wherein the AI agent framework may enable the selection of certain tools and registry to perform the workflow analytics.

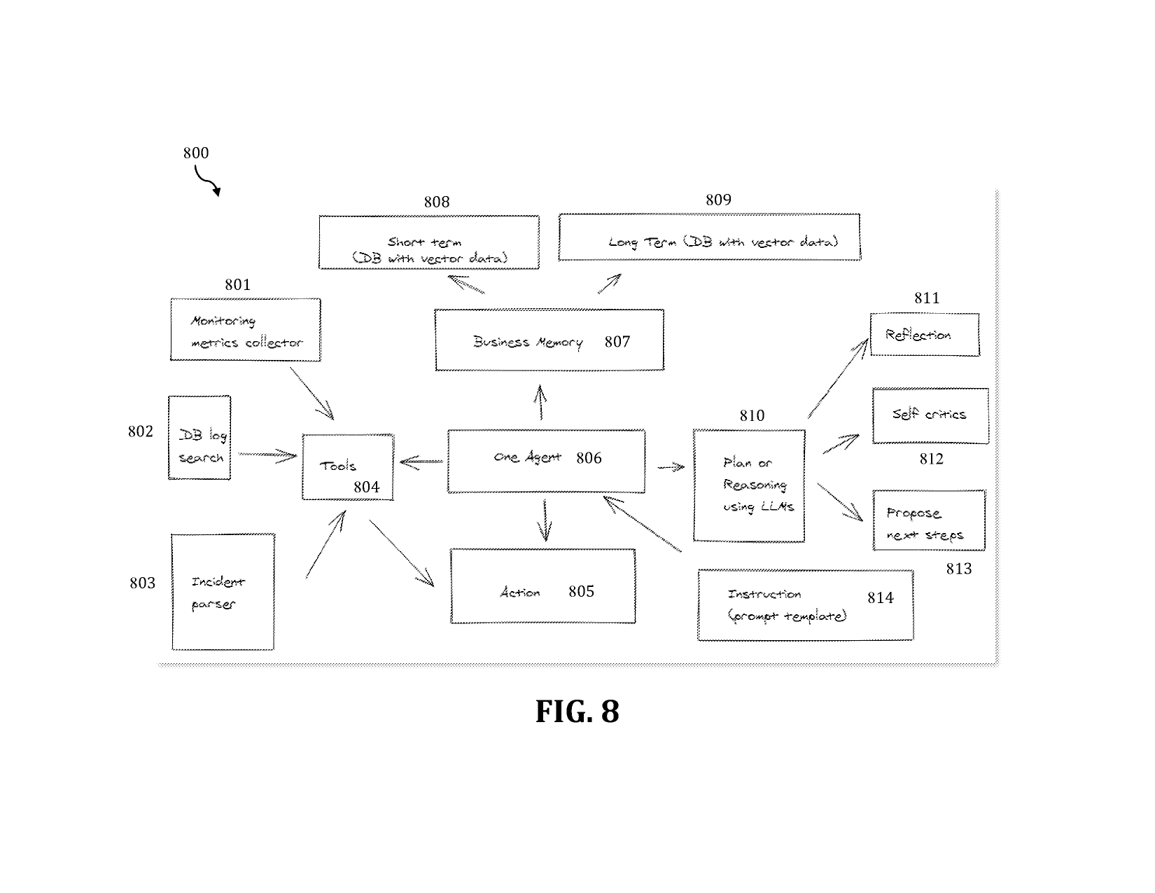

FIG. 8 illustrates an example overview process flow 800 of an AI agent framework performing workflow analytics according to an embodiment. The example overview process flow 800 includes a monitoring metrics collector 801 for monitoring and collecting data, which may then be transmitted to the various tools 804. The example overview process flow 800 also includes a database (DB) log search 802 that collects DB log data and an incident parser 803 that parses incidents to collect incident data, wherein the DB log data and parsed incidents may then be transmitted to the various tools 804. An action 805 or actions may be generated from the various data based on the received data from the various tools 804.

Continuing with FIG. 8, one agent 806 (i.e., one AI agent) may access data from business memory 807, action 805, tools 804, and plans/reasoning using LLMs 810. The business memory 807 that may have short-term data 808 (as stored as vector data in a DB) or long-term data 809 (as stored as vector data in a DB), wherein the short-term and/or long-term data in this vectorized form may be used in training the LLMs to generate predictive data (e.g., forecasting answers, forecasting future results/events, etc.). The one agent 806 may also receive instructions or prompt templates 814. The instructions or prompt templates 814 may be received from a user using natural language processing (NLP) such that the one agent 806 may understand the instructions or prompts.

Continuing with FIG. 8, the plans/reasoning using LLMs 810 may including reflection 811 on the plans/reasons/results, self-critics 812 (e.g., self-critiquing of the plans/reasoning), and proposing of next steps 813 that may be undertaken. For example, to build the one agent 806 (i.e., one AI agent), a model integration framework may be used to link the LLM with other LLMs and/or with tools (e.g., custom tools and/or pre-existing standard tools) that may execute certain steps, perform certain operations, or provide input to the LLM that enables the LLM to reflect on its own result and calibrate the LLM via training to generate better results for a next input.

Additionally, while FIG. 8 shows one agent 806 (i.e., one AI agent) as an example, a plurality of such agents may be built in a similar manner, resulting in a farm of such AI agents performing a variety of different workflow analytics. Different business/enterprise teams may build various applications to leverage this farm of AI agents for different use cases, e.g., production support, recovery applications, etc.

The AI agent framework may be built on top of a machine learning (ML) framework. An example of a ML framework may include a plurality of layers, such as, but not limited to, an applications layer; a ML processing layer; a LLMs layer; a data processing layer; and a raw data layer for obtaining raw data. The applications layer may be positioned as a top layer in the ML framework, followed by the ML processing layer, the LLMs layer, the data processing layer, and the raw data layer as the bottom layer of the ML framework. In an example, the AI agent framework may be incorporated into the applications layer of the ML framework.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method of performing workflow analytics, the method being implemented by at least one processor, the method comprising:
implementing a first large language model (LLM);
creating a linked chain of LLMs via a model integration framework linking the first LLM with at least a second LLM;
implementing at least one analytical software tool from a tool registry such that each of the at least one analytical software tool is configured to perform a respective data analytics function;
implementing at least one software agent such that each is configured to perform at least one respective operational task;
generating an artificial intelligence (AI) agent framework by connecting the linked chain of LLMs with the at least one analytical software tool and the at least one software agent; and
performing the workflow analytics via the AI agent framework.

2. The method of claim 1, wherein the at least one analytical software tool comprises:
a web crawler software tool configured to perform a first data analytics function of parsing data from web derived sources, wherein the web derived sources comprise at least one from among email data objects, web-based incident reports, and web-based application data;
a monitoring software tool configured to perform a second data analytics function of analyzing, tracking, and parsing incident reports and alerts;
a database software tool configured to perform a third data analytics function of analyzing, organizing, cataloging, and managing data within the database;
a log scanning software tool configured to perform a fourth data analytics function of analyzing data logs; and
a chatbot software tool configured to perform a fifth data analytics function of managing a chatbot and functions of the chatbot.

3. The method of claim 1, wherein the at least one software agent comprises at least one from among:
an incident analysis software agent configured to perform an incident management task;
a LLM test software agent configured to perform a test task of testing a performance of at least one from among the first LLM and the at least second LLM;
a LLM comparison software agent configured to perform a comparison task of comparing the first LLM with the at least second LLM;
a test case refinement software agent configured to perform a test case task of refining a test case;
a decision-making software agent configured to perform a decision task that includes analyzing user queries, interacting with a knowledge base and at least one from among the first LLM and the at least second LLM, and deciding on an action; and
an action execution software agent configured to perform an action execution task of executing the decided action.

4. The method of claim 1, further comprising performing data pre-processing of data that comprises:
splitting the data into categories;
cleaning of the data;
tokenization of the data; and
natural language processing of the data comprising stemming and lemmatization of the data.

5. The method of claim 1, wherein the performing the workflow analytics comprises:
connecting with a cloud computing server and performing data tokenization to generate optimized data for utilization by at least one from among the first LLM and the at least second LLM within the AI framework;
generating embeddings of structured data and generating an index of the embeddings;
training the linked chain of LLMs based on a knowledge base derived from a vector database;
validating at least one from among the first LLM and the at least second LLM by generating a score associated with a response result from at least one from among the first LLM and the at least second LLM to a prompt, wherein the response result comprises a tree response result; and
deploying the validated at least one from among the first LLM and the at least second LLM.

6. The method of claim 5, wherein the training the linked chain of LLMs comprises:
fine-tuning the linked chain of LLMs; and
performing few-shot prompting to generate the response result.

7. The method of claim 1, wherein the performing the workflow analytics further comprises:
receiving a query prompt from a user; and
performing prompt engineering on the received query prompt.

8. A computing apparatus for performing workflow analytics, comprising:
a processor;
a memory;
a display; and
a communication interface coupled to each of the processor, the memory, and the display, wherein the processor is configured to:
implement a first large language model (LLM);
create a linked chain of LLMs via a model integration framework linking the first LLM with at least a second LLM;
implement at least one analytical software tool from a tool registry such that each of the at least one analytical software tool is configured to perform a respective data analytics function;
implement at least one software agent such that each is configured to perform at least one respective operational task;
generate an artificial intelligence (AI) agent framework by connecting the linked chain of LLMs with the at least one analytical software tool and the at least one software agent; and
perform the workflow analytics via the AI agent framework.

9. The computing apparatus of claim 8, wherein the at least one analytical software tool comprises:
a web crawler software tool configured to perform a first data analytics function of parsing data from web derived sources, wherein the web derived sources comprise at least one from among email data objects, web-based incident reports, and web-based application data;
a monitoring software tool configured to perform a second data analytics function of analyzing, tracking, and parsing incident reports and alerts;
a database software tool configured to perform a third data analytics function of analyzing, organizing, cataloging, and managing data within the database;
a log scanning software tool configured to perform a fourth data analytics function of analyzing data logs; and
a chatbot software tool configured to perform a fifth data analytics function of managing a chatbot and functions of the chatbot.

10. The computing apparatus of claim 8, wherein the at least one software agent comprises at least one from among:
an incident analysis software agent configured to perform an incident management task;
a LLM test software agent configured to perform a test task of testing a performance of at least one from among the first LLM and the at least second LLM;
a LLM comparison software agent configured to perform a comparison task of comparing the first LLM with the at least second LLM;
a test case refinement software agent configured to perform a test case task of refining a test case;
a decision-making software agent configured to perform a decision task that includes analyzing user queries, interacting with a knowledge base and at least one from among the first LLM and the at least second LLM, and deciding on an action; and
an action execution software agent configured to perform an action execution task of executing the decided action.

11. The computing apparatus of claim 8, wherein the processor is configured further to perform data pre-processing of data that comprises:
splitting the data into categories;
cleaning of the data;
tokenization of the data; and
natural language processing of the data comprising stemming and lemmatization of the data.

12. The computing apparatus of claim 8, wherein the processor is further configured to perform the workflow analytics by:
connecting with a cloud computing server and performing data tokenization to generate optimized data for utilization by at least one from among the first LLM and the at least second LLM within the AI framework;
generating embeddings of structured data and generating an index of the embeddings;
training the linked chain of LLMs based on a knowledge base derived from a vector database;
validating at least one from among the first LLM and the at least second LLM by generating a score associated with a response result from at least one from among the first LLM and the at least second LLM to a prompt, wherein the response result comprises a tree response result; and
deploying the validated at least one from among the first LLM and the at least second LLM.

13. The computing apparatus of claim 11, wherein the processor is further configured to train the linked chain of LLMs by:
fine-tuning the linked chain of LLMs; and
performing few-shot prompting to generate the response result; and
wherein the processor is further configured to perform the workflow analytics by:
receiving a query prompt from a user; and
performing prompt engineering on the received query prompt.

14. A non-transitory computer readable storage medium storing instructions for performing workflow analytics, the non-transitory computer readable storage medium comprising executable code which, when executed by a processor, causes the processor to:
implement a first large language model (LLM);
create a linked chain of LLMs via a model integration framework linking the first LLM with at least a second LLM;
implement at least one analytical software tool from a tool registry such that each of the at least one analytical software tool is configured to perform a respective data analytics function;
implement at least one software agent such that each is configured to perform at least one respective operational task;
generate an artificial intelligence (AI) agent framework by connecting the linked chain of LLMs with the at least one analytical software tool and the at least one software agent; and
perform the workflow analytics via the AI agent framework.

15. The non-transitory computer readable storage medium of claim 14, the at least one analytical software tool comprises:
a web crawler software tool configured to perform a first data analytics function of parsing data from web derived sources, wherein the web derived sources comprise at least one from among email data objects, web-based incident reports, and web-based application data;
a monitoring software tool configured to perform a second data analytics function of analyzing, tracking, and parsing incident reports and alerts;
a database software tool configured to perform a third data analytics function of analyzing, organizing, cataloging, and managing data within the database;
a log scanning software tool configured to perform a fourth data analytics function of analyzing data logs; and
a chatbot software tool configured to perform a fifth data analytics function of managing a chatbot and functions of the chatbot.

16. The non-transitory computer readable storage medium of claim 14, wherein the at least one software agent comprises at least one from among:
an incident analysis software agent configured to perform an incident management task;
a LLM test software agent configured to perform a test task of testing a performance of at least one from among the first LLM and the at least second LLM;
a LLM comparison software agent configured to perform a comparison task of comparing the first LLM with the at least second LLM;
a test case refinement software agent configured to perform a test case task of refining a test case;
a decision-making software agent configured to perform a decision task that includes analyzing user queries, interacting with a knowledge base and at least one from among the first LLM and the at least second LLM, and deciding on an action; and
an action execution software agent configured to perform an action execution task of executing the decided action.

17. The non-transitory computer readable storage medium of claim 14, wherein the executable code further causes the processor to perform data pre-processing of data that comprises:
splitting the data into categories;
cleaning of the data;
tokenization of the data; and
natural language processing of the data comprising stemming and lemmatization of the data.

18. The non-transitory computer readable storage medium of claim 14, wherein the executable code further causes the processor to perform the workflow analytics comprising:
connecting with a cloud computing server and performing data tokenization to generate optimized data for utilization by at least one from among the first LLM and the at least second LLM within the AI framework;
generating embeddings of structured data and generating an index of the embeddings;
training the linked chain of LLMs based on a knowledge base derived from a vector database;
validating at least one from among the first LLM and the at least second LLM by generating a score associated with a response result from at least one from among the first LLM and the at least second LLM to a prompt, wherein the response result comprises a tree response result; and
deploying the validated at least one from among the first LLM and the at least second LLM.

19. The non-transitory computer readable storage medium of claim 18, wherein the executable code further causes the processor to train the linked chain of LLMs by:
fine-tuning the linked chain of LLMs; and
performing few-shot prompting to generate the response result.

20. The non-transitory computer readable storage medium of claim 14, wherein the executable code further causes the processor to perform the workflow analytics by:
receiving a query prompt from a user; and
performing prompt engineering on the received query prompt.
